(19) United States
(12) Patent Application Publication
(10) Pub. No.: US 2008/0068156 A1
(43) Pub. Date: Mar. 20, 2008

(54) Sensor net system and sensor node

(75) Inventors: Isao Shimokawa, Mitaka (JP); Keiro Muro, Koganei (JP); Minoru Ogushi, Kodaira (JP); Kazuki Watanabe, Hino (JP); Miki Hayakawa, Fussa (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/826,163

(22) Filed: Jul. 12, 2007

(30) Foreign Application Priority Data
Sep. 14, 2006 (JP) 2006-248873

(51) Int. Cl. H04Q 7/00

(52) U.S. Cl. 340/539.22

(57) ABSTRACT

In order to realize the joining with the legitimate devices for joining with a limited number of operations for terminal devices for which small dimension and low power consumption are required, in the radio communication system according to the present invention, a ReJoin Command for instructing the sensor node to join with other PANs is provided, and by the use of this command, it is possible to change the joining of the sensor node joined with an unintended PAN to another intended PAN. In addition, for joining with the PAN to which it is joined is disjoined, repeated attempts are to be made to join with the PAN.

### CLAIM OF PRIORITY

The present application claims priority from Japanese application JP 2006-248873 filed on Sep. 14, 2006, the content of which is hereby incorporated by reference into this application.

### FIELD OF THE INVENTION

The present invention relates to a radio communication system for controlling and operating a large number of sensor nodes such as a sensor net.

### BACKGROUND OF THE INVENTION

Lately, various Sensor Net Systems have come to attract attention for constructing information network systems by combining sensor nodes, gateways and routers, Internet and the like by disposing sensor nodes having a sensor function indoor and outdoor. The Sensor Net System is a system for managing sensing data received from a plurality of sensor nodes installed at different positions by means of host devices such as server and the like through the router base station and the like. It is expected that such a system capable of supervising the condition at the site in real time would be applied to the system of sanitary management, detection of disasters, health care service and the like.

In a system in which such a plurality of sensor nodes are managed in a plurality of base stations, the nodes subject to management must be managed in advance for each PAN. If it is not grasped to which PAN each sensor node belongs, it is impossible to grasp the condition of the periphery where sensing information has been obtained. As an example, the disaster detection system is mentioned. For detecting disaster in the disaster detection system, information on the location of disaster is required.

However, for the joining of the sensor nodes with host devices such as base stations and routers, the sensor nodes not always choose the host devices that the management user intended to choose. Therefore, the relationship of joining between the node and the host terminal may be different from the initial setting.

In the radio LAN system, there has been traditionally a technology of judging whether the terminal addresses that the base station had acquired according to the demand of joining from radio terminals are in the managed list of registered terminals. According to this technology, if the address exists in the registration list, the terminal is authenticated, and the subsequent communications are allowed (for example, see JP-A 2003-319455.)

### SUMMARY OF THE INVENTION

The Sensor Net Management Client must remote control the sensor nodes to construct the intended topology. For constructing the intended system configuration in a large-scale network, for each sensor node to be laid out on a large scale, it is possible to define the configuration of each network in the gateway and router and the sensor node at the time of shipment from the factory but, it is time consuming to set the same individually.

According to the technology that we have mentioned as the conventional example described above, terminals are controlled for allowing joins. However, the terminals that are not allowed to join are not considered. As a result, if the base station is not allowed to communicate, the terminals will be required to operate in order to secure new devices for joining.

Particularly, the sensor node is required to be small in dimension and consuming little power from the viewpoint of convenience of installation. Accordingly, it is required to realize the joining with legitimate devices for joining with little operation.

The object of the present invention is, at the time of designing the Sensor Net System, to solve the issues that emerge when the conventional communication system is applied, to reduce the burden on the human resources for the Management Client, and to provide a suitable radio communication system for realizing extensive and stable communications.

The representative inventions disclosed in this application are summarized as shown below:
The present invention relates to a Sensor Net System including a plurality of intermediate devices joined with a sensor node and a server joined with said base station. In particular, the server includes a record unit for recording the relationship of joining between the node with which it is joined and the network to which the intermediate devices belong, a display unit for displaying the relationship of joining, an input unit for accepting changes in the relationship of joining, a command issue unit for rejoining commands based on the judgment thereof, and a reception and transmission unit for transmitting the issued commands to the intermediate devices joined with the sensor node, and upon the receipt of the command, the sensor node shuts off the joining with the intermediate device, searches the intermediate devices belonging the designated network in the command, and joins with the retrieved intermediate devices.

According to the present invention, in the Sensor Net System, the Management Client can change the PAN of the devices with which the sensor nodes are joined by using a middleware. And the Management Client and the Application Client can acquire the PAN information of the devices to which the sensor node belongs through a middleware.

### BRIEF DESCRIPTION OF THE DRAWINGS

FIG. 1 is a schematic illustration of the radio communication system according to the present invention;

FIG. 2 is a block diagram showing the hardware configuration of the Middleware Server according to the present invention;

FIG. 3 is an illustration describing the constitution of the GUI according to the present invention;

FIG. 4 is a block diagram showing the hardware configuration of the gateway according to the present invention;

FIG. 5 is a block diagram showing the hardware configuration of the router according to the present invention;

FIG. 6 is a block diagram showing the hardware configuration of the sensor node according to the present invention;

FIG. 7 is a conceptual illustration of the ReJoin Command according to the present invention;

FIG. 8 is a sequence chart for the ReJoin Command according to the present invention;

FIG. 9 is an illustration describing changes in state relating to the Deep Join operation according to the present invention;

FIG. 10 is a conceptual illustration of the Active Scan according to the present invention;

FIG. 11 is a conceptual illustration of the Deep Join operation according to the present invention;

FIG. 12 is an illustration describing changes in state relating to the Shallow Join operation according to the present invention;

FIG. 13 is a conceptual illustration of the Shallow Join operation according to the present invention;

FIG. 14 is a sequence chart for the Shallow Join operation according to the present invention;

FIG. 15 is an illustration describing changes in state relating to the Join operation according to the present invention;

FIG. 16 is a sequence chart for the Join operation according to the present invention;

FIG. 17 is a conceptual illustration describing the refabrication operation of topology according to the present invention;

FIG. 18 is an illustration describing the constitution of the GUI according to the present invention;

FIG. 19 is a sequence chart relating to the BeJoined event according to the present invention;

FIG. 20 is an illustration describing the constitution of the GUI according to the present invention;

FIG. 21 is a block diagram showing the hardware configuration combining the RF-ID and sensor node according to the present invention;

FIG. 22 is a block diagram showing the configuration of the anti-cross talk system according to the present invention;

FIG. 23 is a conceptual illustration describing the time-sharing according to the present invention;

FIG. 24 is a conceptual illustration of the sequence chart in the operation of the anti-cross talk system according to the present invention;

FIG. 25 is a conceptual illustration of the sensor node according to the present invention;

FIG. 26 is a conceptual illustration of the system with RF-ID reader (Reader and Remote Control) according to the present invention; and

FIG. 27 is a conceptual illustration of the sensor node according to the present invention.

### DETAILED DESCRIPTION OF THE PREFERRED EMBODIMENTS

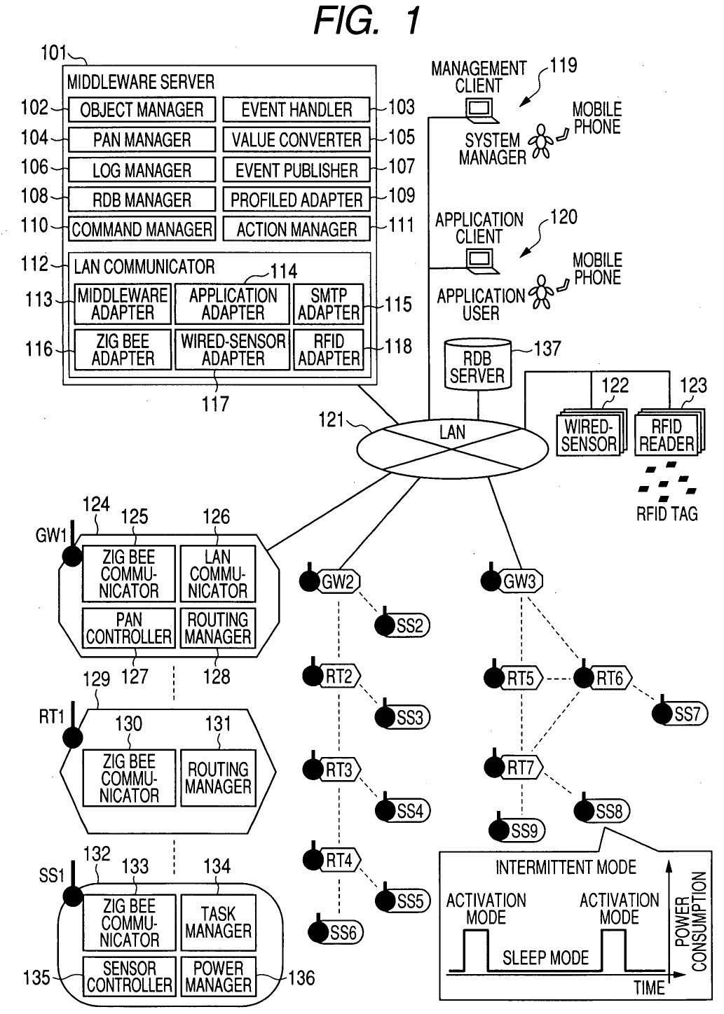

We will describe below the first embodiment of the radio communication system according to the present invention. FIG. 1 shows a schematic illustration of the communication system of this embodiment. The system includes a Middleware Server (101) for controlling the entire system, a LAN (121), a RDB server (137), a gateway (124), a router (129) and a sensor node (132). The gateway, router, and sensor node constitute the radio network. Each PAN (Personal Area Network) includes a base station, one or more routers and a plurality of sensor nodes. For example, the system uses a short-distance radio communication standard Zigbee as the radio communication standard. It includes middleware and firmware as software. The middleware converts the information useful to the Management Clients (119) and the Application Clients (120) into an easily understandable form and transmits the same succinctly. And the firmware controls the hardware apparatuses of the gateway, the router and the sensor nodes. We will describe below each of these apparatuses in detail.

The Middleware Server (101) transmits the sensing information received from the gateway to an unspecified large number of users through the web server. The Application Client can acquire the sensing information transmitted from the Middleware Server on the personal computer through the IP network. A system may be constructed by joining not only with a small network within a company as an IP network but with the Internet which is a large-scale IP network. The Management Client can transmit commands from the GUI to each gateway, router and sensor node to give instructions on operation. For these instructions, the Management Client gives instructions to the gateway, route and sensor nodes by using the MAC Addresses which are the proper ID for the hardware. The gateway transmits the sensing information received from the routers and the sensor nodes to the Middleware Server through the IP network.

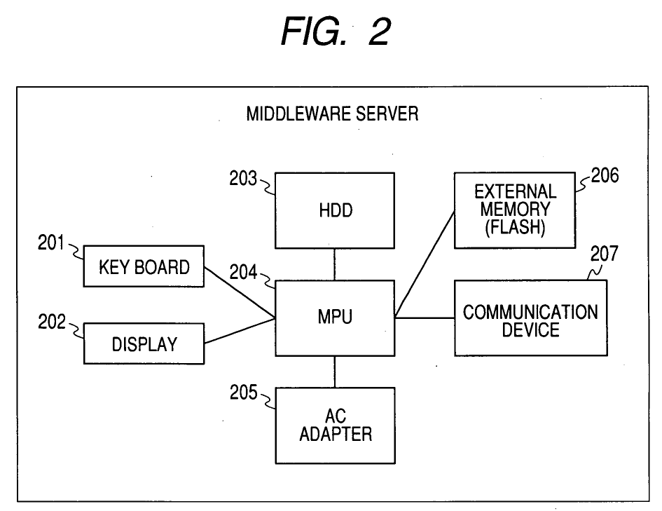

FIG. 2 shows the configuration of hardware of the Middleware Server. The Middleware Server includes a key board (201), a display (202), a HDD (203), a MPU (microprocessor) (204), an AC Adapter (205), a memory (206), and a communication device (207). A GUI is displayed on the display. The communication device communicates by cable to transmit sensing information to the Management Client and the Application Client. In addition, the MPU reads programs to realize the configuration of the Object Manager (102), the Event Handler (103), the PAN Manager (104), the Value Converter (105), the Log Manager (106), the Event Publisher (107), the RDB Manager (108), the Profiled Adapter (109), the Command Manager (110), the Action Manager (111) and the LAN Communicator (112).

The Object Manager manages the information transmitted from the gateway on the Object Table (304). The Object Manager manages, for example, the MAC Addresses, the Network Addresses, the PAN ID and the like of the gateway, the router and nodes. The GUI displays the information managed by the Object Manager. The Event Handler is a socket for the packet data received by the LAN Communicator. The PAN Manager is a kind of Event Handler. It defines the type of the data received from the LAN Communicator and transmits the same to the Object Manager. The Value Converter is also a type of Event Handler and converts the received data into the real data that the Application Client and the Management Client can make out. For example, the Value Converter converts the AD converted value of a temperature sensor into a real temperature. The Event Publisher sorts the received events among the Event Handlers such as the PAN Manager, the Value Converter and the like. The RDB Manager stores the data received from the Event Publisher in the data base. And the RDB Manager transmits data to the RDB server through the Middleware Adapter. The Profiled Adapter prescribes the definition of the command structure, and converts the packet information received by various LAN Communicators into the common event form. The Profiled Adapter transmits packets corresponding to various events to the Event Publisher. For example, when the event of transmitting regularly packets containing temperature data from the sensor nodes is defined as an observation event, the Profile Adapter describes the definition of form (temperature, humidity and the like) corresponding to the observation event, and converts the data into a structure that the higher-level layer can interpret. As the structure that the higher-level layer can interpret, for example, XML (Extensible Markup Language) can be mentioned. The Command Manager transmits commands to the Profiled Adapter, and the Profiled Adapter makes the packet for the commands and sends them to the sensor nodes. The Action Manager transmits the events received from the GUI to the Command Manager. The LAN Communicator transfers the data of the lower layer received from various devices to the Profiled Adapter. The LAN Communicator has a socket corresponding to various cable and radio protocols. The LAN Communicator includes a Middleware Adapter (113), an Application Adapter (114), a SMTP Adapter (115), a Zigbee Adapter (116), a Wired-Sensor Adapter (117) and a RFID Adapter (118). These adapters are the receivers and transmitters of packet of various protocols. The Middleware Adapter communicates via socket communication with the middleware of the Management Client (Management Client). The Application Adapter communicates via socket communication with the applications of the Application Client. The SMTP Adapter transmits e-mails via SMTP communication to the Application Client (Application Client). The Zigbee Adapter communicates via Zigbee protocol communication with the gateway. The Wired-Sensor Adapter communicates via protocol communication adapted to wired sensors with wired sensors. The RFID Adapter communicates via protocol communication adapted to RFID with RFID readers. The RDB Server manages sensor data.

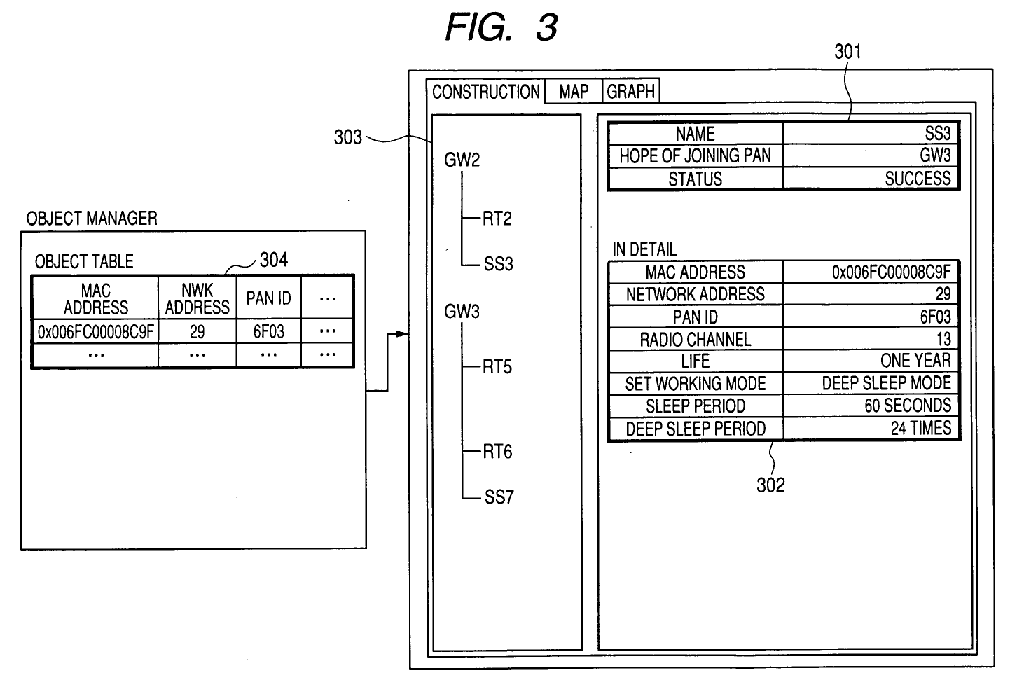

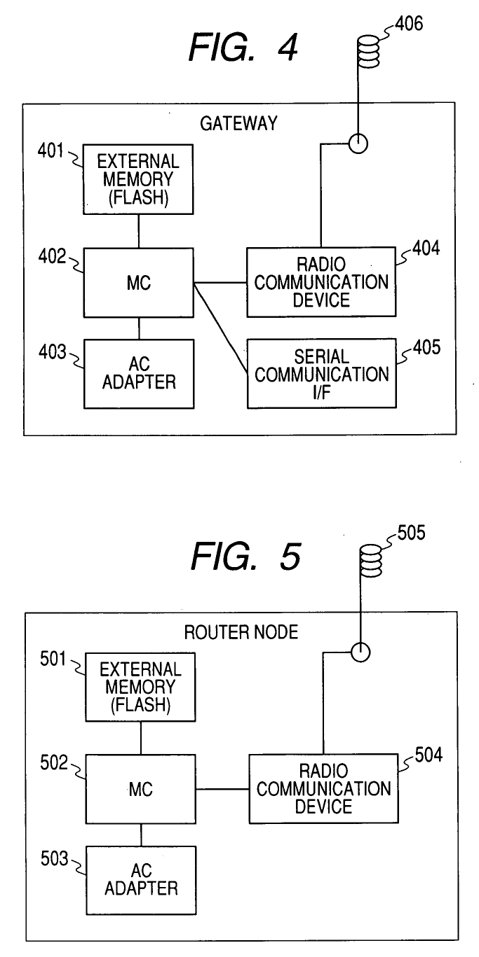

FIG. 3 shows an example of configuration of the GUI displayed in the Display 202. The GUI acquires data from the Object Table (304) in the Object Manager. The GUI displays necessary information for the management of system. Such necessary information includes changes in temperature due to location and changes in time, detailed sensor node information (radio channel, PAN ID, Network Address, sleep interval) (302) and the like. On the GUI the name of the sensor node and the desired PAN are inputted (301). The Management Client (Management Client) acquires the sensor node information on the GUI and inputs the PAN to which it is desired to belong. In this way, the GUI interprets and gives instructions to the sensor node through the middleware. The basic operations of the MPU include reading of programs such as middleware stored into the memory, receiving data from the input device, the storage device according to the instruction of the program, executing the data precisely according to the program and transferring the data to the storage devices such as memory and to the output devices such as display.

The gateway (124) has a firmware having four functions including a Zigbee Communicator (125), a LAN Communicator (126), a PAN Controller (127), and a Routing Manager (128). And the gateway has a Binding Table. The Binding Table registers communicable nodes. This Binding Table includes a Binding Type, a Local Endpoint, a Remote Endpoint, a Cluster ID, a MAC Address and a Network Address. The Binding Type is allocated uniquely to the communicable router and sensor nodes with the gateway, and the information relating to nodes such as MAC Address and the like corresponding to the allocated Binding Type is stored in the Binding Table. The endpoint is a unique ID for establishing communications with the routers and the sensor nodes, and is similar to the IP Address. The IP Address is an identification number allocated to each computer or communication apparatus joined with the IP network such as the Internet or intranet. The Local Endpoint is the Endpoint of the gateway, and the Remote Endpoint is the endpoint of the node at the other end of the line of communication. The Cluster ID is the unique ID corresponding to the instruction given by the gateway to the nodes and is similar to Port. The Port is an auxiliary address created under the IP Address in order to join simultaneously with a plurality of devices for joining in a communication on the Internet. The Network Address is a unique ID arranged among the gateway, the router and the sensor nodes. Regarding the Network Address, the gateway constructing the PAN has an ID number of 0, and the nodes other than the one constructing the PAN respectively make arrangements to allocate their own numbers. For example, if the maximum number of sensor nodes accessible to the router is 9, the Network Address of the router is 10, and the sensor nodes joined with the router are allocated the number of 11, 12, 13 and so forth. And the other routers are allocated with a number equivalent to the integer multiples of 10. For communication, it is possible to communicate with the router and the sensor nodes registered in the Binding Table by specifying only the Binding Type. The gateway interprets the data received by radio from the router and the sensor nodes and transmits by cable information to the Middleware Server.

The router (128) has a firmware having two functions of a Zigbee Communicator (129), and a Routing Manager (130). The router uses a table to identify the route of transmission to the sensor nodes. It uses the Routing Manager to select the route and to perform the routing processing to the sensor nodes. Thereafter, the router receives the sensing information transmitted from the sensor node and transmits by radio wave the received sensing information to the gateway via the Zigbee Communicator. FIG. 5 shows the hardware configuration of the router. The router includes an External Memory (flash) (501), a MC (502), an AC Adapter (503), a Radio Communication Device (504), and an Antenna (505). The Zigbee Communicator corresponds to the Radio Communication Device. The Routing Manager executes controlling operations by the MC.

The sensor node (131) has a firmware having four functions including a Zigbee Communicator (132), a Task Manager (133), a Sensor Controller (134) and a Power Manager (135). The sensor node has the basic operation mode of operating intermittently taking into account the possibility of extending the Battery life. The sensor node executes sensing operation regularly and transmits the sensing information to the gateway. If no gateway exists within the range of coverage of the radio wave of the sensor node, it communicates with the gateway via a router existing within the range of coverage of the radio wave of the sensor node. If no gateway and router exists within the range of coverage of radio wave of the sensor node, the sensor node enters in an extended period of sleep. In order to establish communication with the gateway and router, the sensor node begins a Deep Join operation. After the Deep Join operation, the sensor node begins communicating with the gateway and the router. The Power Manager alternates at fixed intervals two states, i.e., the sleep state resulting from the operation of turning off the power for everything other than the timer circuit (RTC and the like) on one hand and the operating state resulting from the operation of turning on the power for all the circuits on the other hand. In the operating state the sensor node executes sensing operation by the Sensor Controller by using various sensors. The information obtained by the sensing operation is stored in packets in the MC of the sensor node, and is transmitted via radio wave to the gateway and router through the Zigbee Communicator. And it manages the tasks in the sensor node by the Task Manager.

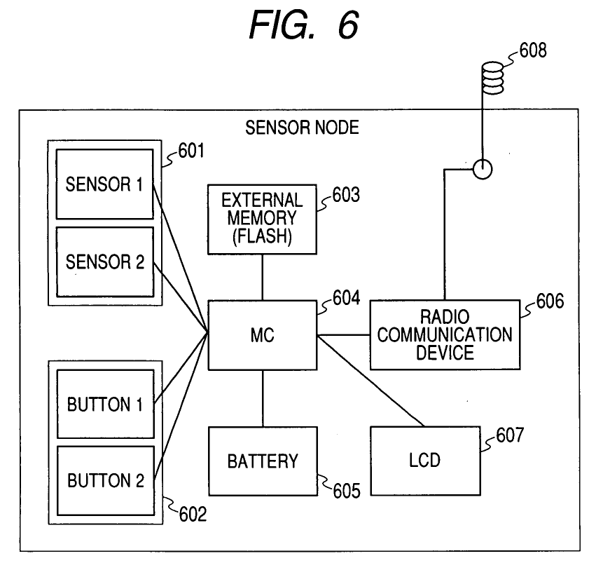

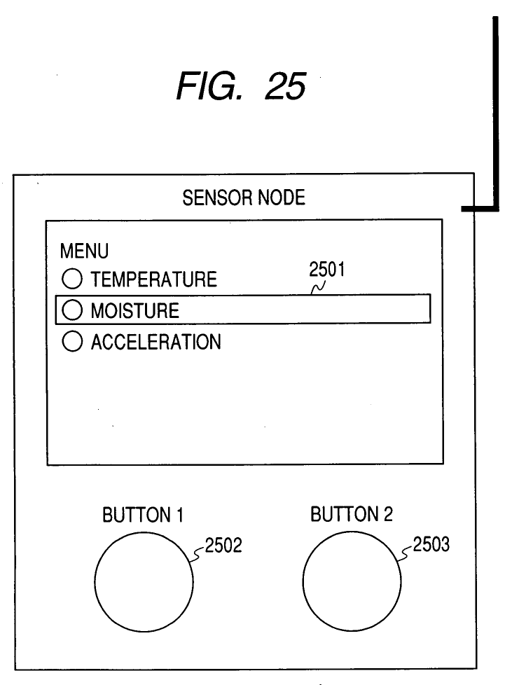

FIG. 6 shows the configuration of hardware of a sensor node. The sensor node includes a plurality of sensors (601), a plurality of button switches (602), an External Memory (603), a MC (604), a Battery (605), a Radio Communication Device (606) a LCD (607) and an Antenna (606). The Zigbee Communicator corresponds to the Radio Communication Device. The Task Manager, the Sensor Controller and the Power Manager are controlled by the MC. The LCD can display, for example, the menu 2501 (temperature, humidity and acceleration) shown in FIG. 25. Furthermore, it is possible to create button switches 2502 and 2503 in the node, and to display the value of the corresponding sensing data by the selection of menu through the operation of the button switches. The Application Client can confirm the information displayed on the display. And as the examples of other acquired data, there are distortion, light intensity, and the like. A Sensor Net System having the various devices mentioned above is created. For constructing the system, each gateway constructs a personal area network (PAN) as an operation following immediately each gateway. The Management Client issues a formed PAN command, which is a command for constructing a PAN on the GUI. The formed PAN command includes a PAN ID and a radio channel. Then, the GUI transmits an issue instruction of formed PAN command and information such as PAN ID, radio channel and the like to the Action Manager in the XML format. The Action Manager transmits to the Profiled Adapter an issue instruction of the formed PAN command and the information on the PAN ID and the radio channel. The Profiled Adapter creates the packet for transmitting to the gateway via the EtherCable by using the information on the radio channel and the PAN ID transmitted from the Action Manager. The gateway can also constitute a PAN by means of a button switch. Upon receipt of a formed PAN command, the gateway constructs a PAN by using the PAN ID and the radio channel contained in the command. The construction of a PAN means the setting up of the radio channel in the formed PAN command in the Radio Communication Device of the gateway. The gateway can transmit and receive packets corresponding to the channel. And the gateway informs the sensor node with which it has been joined of the PAN ID.

For constructing a system, the gateway and the router should be kept in the “Allow Join” state. The instruction “Allow Join” or “Not Allow Join” may also be given by the operation of a button. The Middleware Server and the gateway are joined to begin with, and the instruction of constructing a PAN is given from the Middleware Server to the gateway. The gateway constructs a PAN, and then establishes a communication with the router and the sensor nodes. The router and the sensor nodes start a Deep Join operation to voluntarily establish a communication with the gateway and start communicating. After joining with the gateway, the sensor node transmits regularly sensing information. The router transmits the received sensing information to the gateway. The gateway transmits the received sensing information by cable to the Middleware Server. Upon receipt of the sensing information, the Middleware Server transmits the sensing information via the IP network to the application of other Application Clients. Then the Management Client transmits commands to each sensor node via the Middleware Server by using the GUI and manages the system. The Sensor Net System autonomously determines the router and the gateway to which the sensor node belongs and constructs the system.

We will describe here on the Deep Join operation. FIG. 9 is a schematic illustration describing changes in the Deep Join operation, and FIG. 11 is a conceptual illustration of the Deep Join operation. The Deep Join operation is characterized in that the sensor node searches the PAN that never fails to communicate.

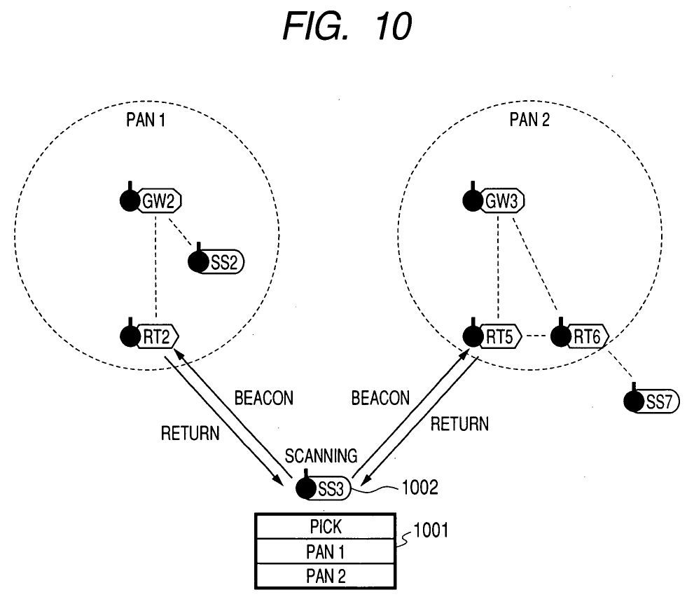

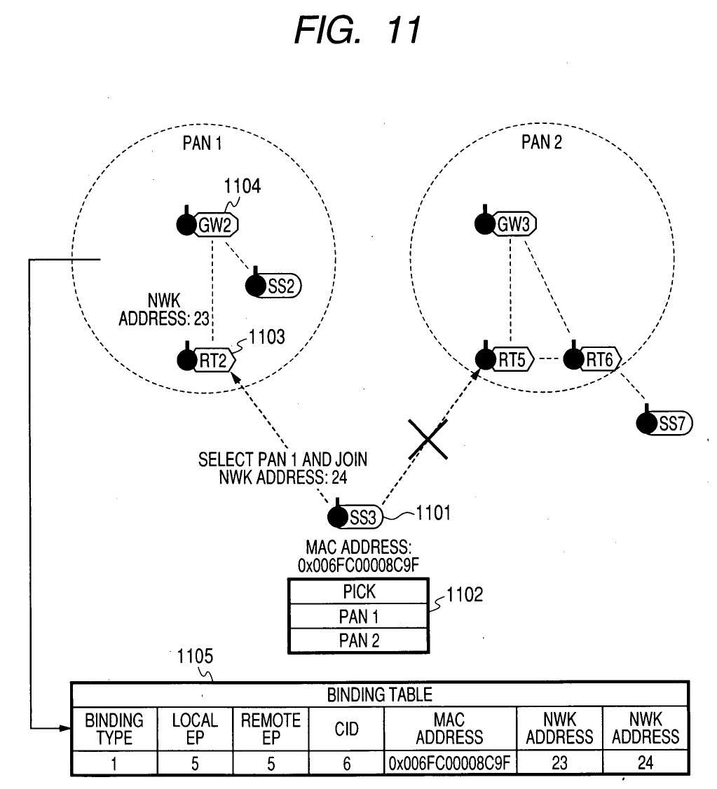

Such changes in state are found in the firmware of all the sensor nodes and routers. At the time of shipment from factory, the node is in the NO_PAN state in which there is no PAN to join. In this case, the node begins searching the communicable PAN at first. If, after transmitting beacon packets by broadcasting (1002), the node receives their returned packet Ack, it registers the PAN information contained in the returned packet in the table of candidates for joining managed in the RAM of the sensor node (1001). It should be noted here that the node transmits by broadcasting only beacon packets for searching the base stations and all the other communications are made by unicasting. For example, as shown in FIG. 10, if there are a plurality of communicable PANs such as PAN1, PAN2 and so forth (1001), the node chooses one of the PAN candidates (903) and joins with the same by using the chosen PAN ID and radio channel. If it succeeds to join, the node shifts to joining (905). If it fails to join, it tries to join with other retrieved PANs. If there is no communicable PAN, after a sleep, the node resumes searching PAN. If, after the Joining state, the node transmits packets to the gateway and receives their return, the node shifts to the Joined state.

In searching PANs, moreover, the radio wave intensity of the returned packet from the router and the gateway may be measured, and the PANs may be registered in the order of the intensity of radio wave. As the yardstick for measuring the intensity of radio field, RSSI (Receive Signal Strength Indicator) is used. If the method of joining with PAN according to the order of intensity of radio field is adopted, it is possible to construct a system with a high stability as a low PER (Packet Error Rate) radio communication system.

The router subjected to a Deep Join operation (1103) transmits the Network Address and the MAC Address of the sensor node to the gateway (1104). And the gateway subjected to a Join operation registers the MAC Address and the Network Address on the Binding Table (1105).

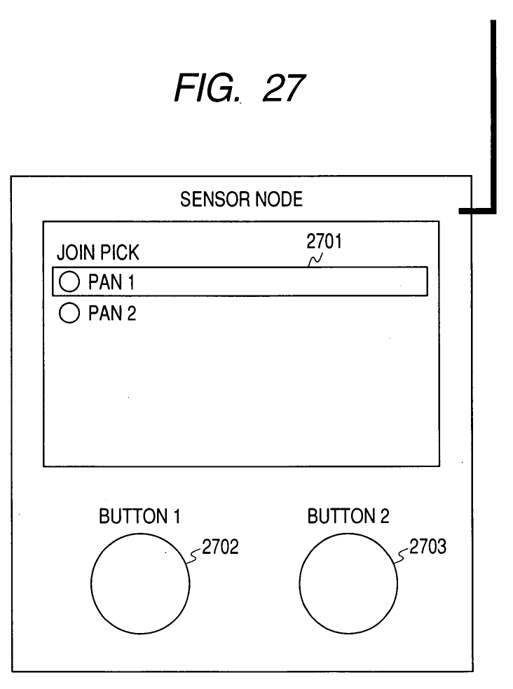

And the Management Client not only controls the sensor node by transmitting commands from the middleware but also can control the sensor node by operating a button. FIG. 27 shows an example of the external view including the LCD display screen of a sensor node. The sensor node searches PANs as a part of the Deep Join operation vis-à-vis the router and the gateway, and displays the acquired PAN candidates on the display. The sensor node starts a Deep Join operation on the chosen PAN (2701) by choosing with a button switch one of the join candidates shown on the display (2702, 2703). And the sensor node disjoins by choosing the disjoin button and the disjoin mark on the display screen. If the disjoin button switch is pressed after the sensor node had joined the PAN, the sensor node begins a Join operation to the PANs other than the PAN to which it had joined among the initially retrieved PAN candidates. The sensor node can disjoin by using buttons (2702, 2703) shown on the hardware. If the disjoin button switch is pressed after the sensor node had joined the PAN, the sensor node begins a Join operation to the PANs other than the PAN to which it had joined among the initially retrieved PAN candidates. The display of such a sensor node may be set. By so doing, not only the control of the sensor node by the command of the middleware, but also by the manipulation of a button switch on the site, the sensor node can be controlled and it will be possible to flexibly cope with the situation. The sensor node for executing the Deep Join operation mentioned above is used to fabricate topology.

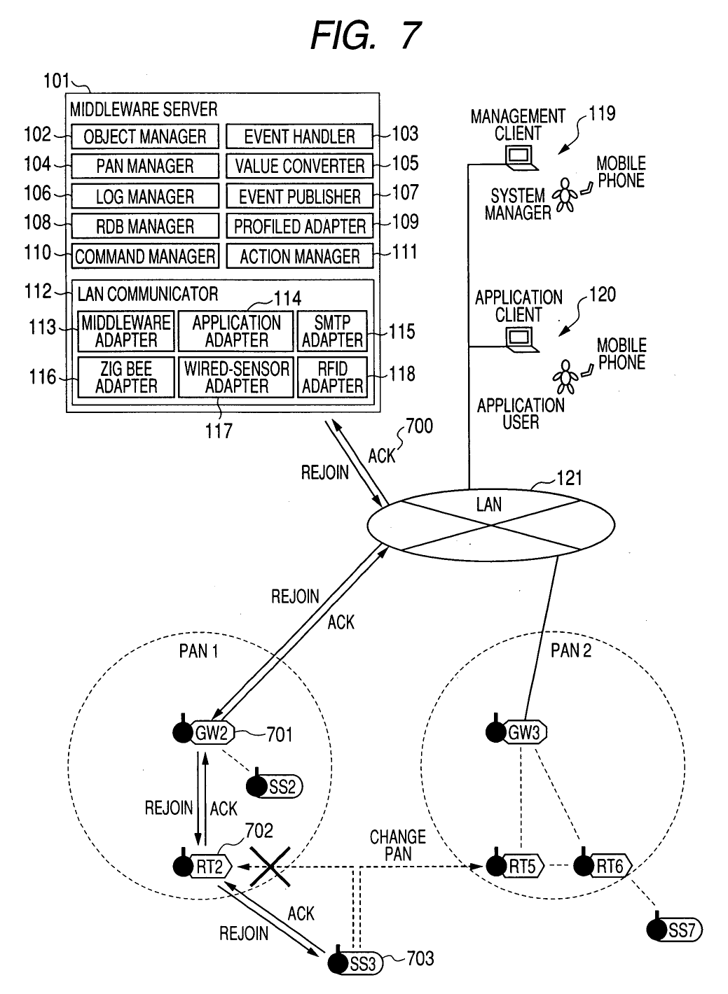

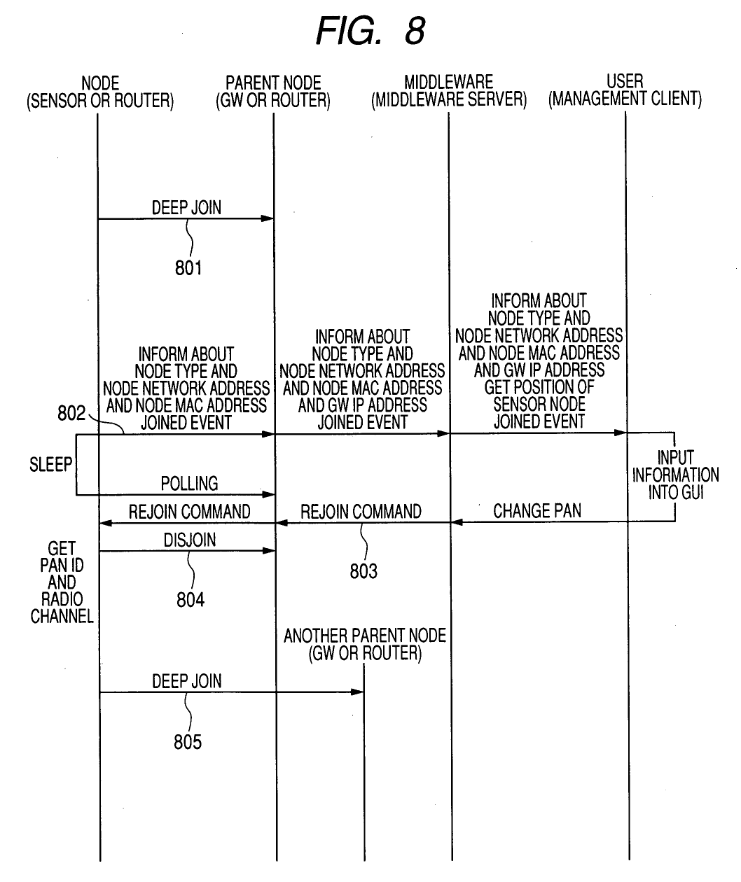

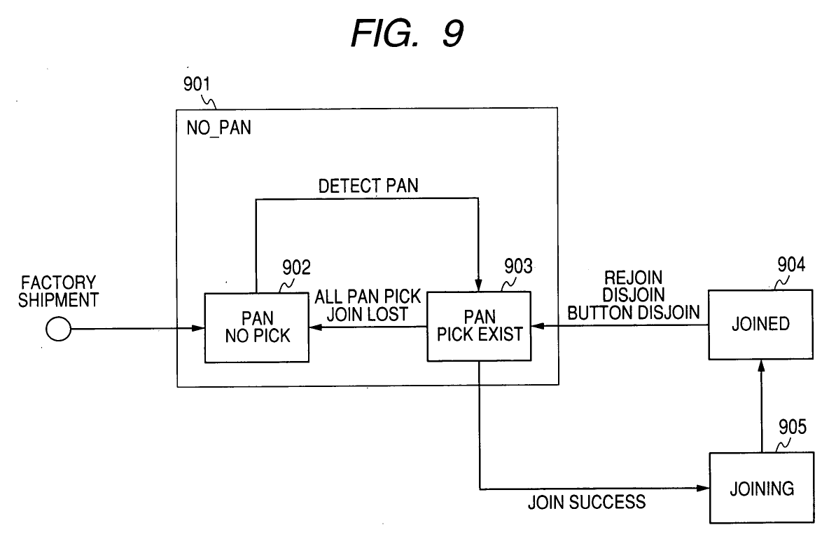

We will show below an embodiment wherein ReJoin Commands are used for reconstituting the system by using these devices. FIG. 7 shows a schematic illustration of reconstituting the system by using Rejoin Commands, and FIG. 8 shows a sequence chart relating to the Rejoin Commands. In this embodiment, it is not initially set to which PAN the sensor node will be joined, and a program by which the PAN constituting the device for joining can be specified by using commands and the construction of system can be flexibly addressed.

To begin with, the sensor node starts a Deep Join operation on the gateway and the router (801). Then, if the gateway sends back a return package, the sensor node issues a Joined event to the gateway and the router (802). The Joined event is an event of transmitting the MAC Address, the Network Address and Node Type of the sensor node, and the IP Address of the gateway to the middleware. The Node Type is an ID for defining the type of the node (sensor, router, gateway and the like). Then, the sensor node sleeps until a Polling is conducted at the predetermined timing. The Polling is a method of enquiring each correspondent of communication whether they have any request for transmission (or processing).

We will then describe the ReJoin Command. Users manage the relationship of join between the sensor node and the router through a GUI as shown in FIG. 3. Here, upon discovering any sensor node separated from the desired relationship of joining, the user instructs a change in the PAN ID for the sensor node. Upon the instruction of the user to change the PAN ID, a demand for the issue of ReJoin Command is transmitted to the Command Manager (110). Upon receipt of the issue demand for a ReJoin Command, the Command Manager transmits the ReJoin Command to the gateway (701) via the Profiled Adapter 109 and the Zigbee Adapter 116 (700). The ReJoin Command includes the changed PAN ID and the NWK address. The gateway (124) receives the ReJoin Command transmitted from the Middleware Server by the LAN Communicator 126, and transmits the command to the router (702) and the sensor node (703) via the Zigbee Communicator. The router (129) transmits the received command to the sensor node (132) via the Zigbee Communicator 130 by using the Routing Manager 131. At this point, the sensor node according to this embodiment acknowledges the existence of communicable gateways and routers by Polling at the predetermined timing on the assumption of intermittent operation. If the returned values of the Polling are equal to or lower than the prescribed value, the sensor node sleeps again, and repeats Polling. Therefore, if the higher-level devices keep holding ReJoin Commands at the timing of receiving the returned data of Polling, the sensor node receives the ReJoin Command.

And the relationship of joining between the node and the router node to which it should belong may be kept in the server as a table, and the consistency of the relationship of joining notified by the sensor node may be automatically judged. In this case, in the reconstruction of this relationship, the separate gateway and sensor node start Join operations, and after the Join operation, a Joined event is issued and is transmitted from the Zigbee Communicator of the Middleware Server to the Profiled Adapter, the Event Publisher and the Object Manager. The consistency between the IP Address of the gateway transmitted to the Object Manager and the IP Address of the gateway contained in the table describing the relationship of join within the Object Manager is judged, and if they are inconsistent, a new ReJoin Command is issued again. Upon receipt of the ReJoin Command via the Zigbee Communicator 133, the sensor node disJoins the communication with the PAN1 (804) after receiving the command. The PAN ID and radio channel received after the disruption of communication with the PAN1 are used to start a Deep Joint operation with the PAN2 (804). If there is no PAN corresponding to the received PAN ID and radio channel, a search is undertaken for communicable PANs and one of a plurality of communicable PANs is chosen, and the sensor node joins with the chosen PAN, and in case of a failure, it joins with another communicable PAN. The search for PAN here means the search for the communicable gateway and router. A series of operations including this search for PAN is particularly called “the Deep Join operation.” After a successful joining with the PAN, a Joined event is issued on the GUI to transmit the information of the PAN with which communication has been established successfully. The PAN Manager compares the received PAN information with the PAN to which it hopes to belong, renews the status parameters displayed on the GUI, and transmits the information of success or failure of refabricating topology to the Application Client. In this embodiment, any Join operation upon the receipt of a ReJoin Command is based on the assumption of a Deep Join operation. Therefore, even if joining with the specified PAN is impossible, the sensor node will ultimately be joined with any one of the PANs.

In this embodiment, not only the sensor node but also the router may be operated intermittently for saving power. However, the router is driven by the power source as its basic mode of operation, and the sensor node is battery driven as its basic mode of operation. As a result, the sleep interval may be different. For example, in the case of sensor node, the adoption of a system wherein the sleep interval is extended for each failure of search for PAN will enable to reduce the power consumption. Making intermittent control possible depending on the situation will enable to save more time of power consumption than intermittent sleep at fixed intervals. On the other hand, the router always sleeps at fixed intervals even if it fails in its search for PAN. Since the router is power-driven, it is not necessary to take into consideration its consumption of power in comparison with the sensor node. However, since it is power-driven, in the case of a failure in its search for PAN, if it resumes the search for PAN immediately, if there are a large number of routers, and if all the routers begin searching for PAN, packets will collide frequently.

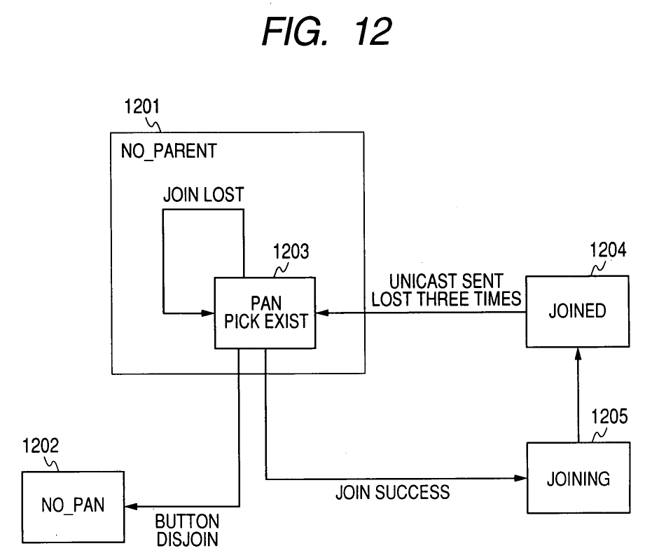

Then the evolution up to the Joined state we described in the second embodiment of the present invention with reference to FIG. 12 is similar to the Deep Join operation. The Shallow Join operation is an operation that occurs when the communication with the PAN is disrupted after the Deep Join operation. In the case of a failure of transmitting packets for a value equal to or more than the prescribed value after the Joined state, the node shifts to a NO_PARENT state (1201) wherein it is impossible to join although there is a PAN to join with. Then, the node joins with the PAN with which it has succeeded to join to shift to the Joining state (1206). If it fails to join, it sleeps and after the sleep it tries to join again. This attempt to join is repeated until it is possible to join.

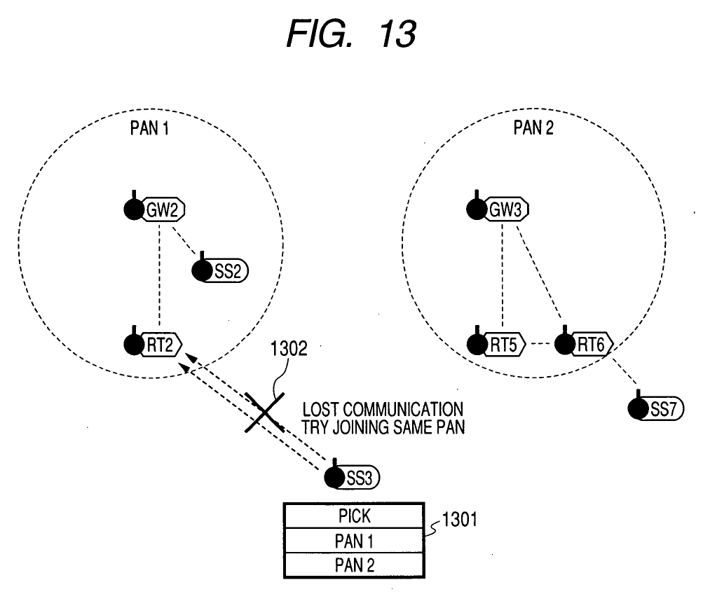

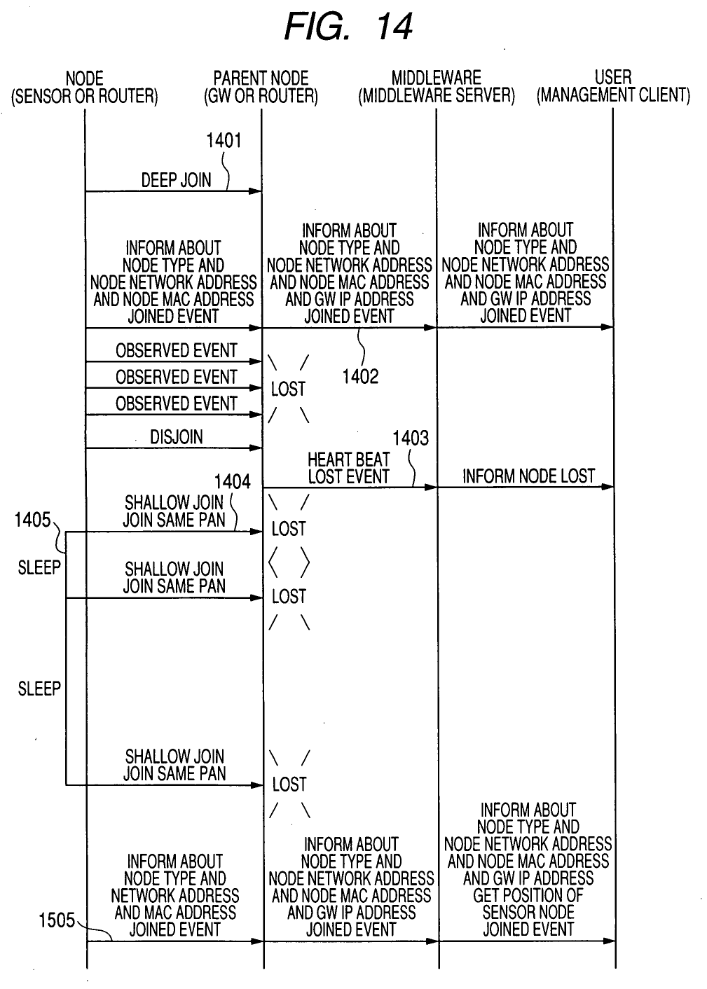

FIG. 13 shows a conceptual illustration of Shallow Join operation, and FIG. 14 shows a sequence chart relating to the Shallow Join operation. The sensor node starts a Deep Join operation on the gateway and the router and establishes communications with the PAN. After the Deep Join operation, the sensor node issues a Joined event of informing the middleware of the MAC Address, the Network Address of the sensor node and the IP Address of the gateway for the gateway and the router and establishes communications with the PAN1. After joining with the PAN, the sensor node transmits regularly sensing information. In the case of failures to communicate this Observed event for a value equal to or more than the prescribed value, it starts a Shallow Join operation of resuming Join operation with the PAN with which the joining has been disrupted (1404). It resumes the Join operation with the PAN1 with which it had been joined until just a little while ago (1302). Then, if the sensor node failed in a Shallow Join operation (1404), it sleeps (1405) and after the sleep it resumes the Join operation. Then, if it succeeds in the Shallow Join operation, the sensor node issues a Joined event of transmitting the Network Address and the MAC Address, the Node Type and the IP Address of the gateway to the middleware. If the communication with the PAN1 with which it had been joined is disrupted, the adoption of the configuration as shown in this embodiment will enable to reduce the consumption of power in comparison with the case of starting a Deep Join operation of searching again another PAN.

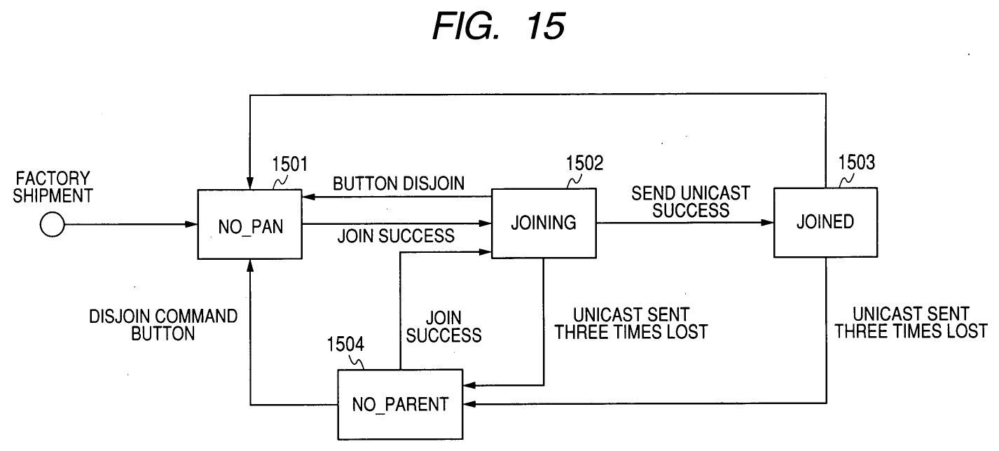

FIG. 15 shows changes in state relating to the Join operation resulting from the combination of a Shallow Join operation and a Deep Join operation. At the time of shipment from factory, the sensor node is in the No_PAN state (1501) in which there is no PAN to join. The sensor node starts a Deep Join operation from the No_PAN state, and if it succeeds in the Join operation with the router and the gateway, it shifts to the Joined state (1502). In the Joining state, the sensor node starts a unicasting communication to the router and the gateway, and if it succeeds in the communication, it shifts to the Joined state (1503). If the sensor node fails in the unicasting communication for a value equal to or more than the prescribed value in the Joining state, it shifts to No_PARENT state (1504). It starts a Shallow Join operation of resuming a Join operation with the base station with which it had failed to join for a value equal to or more than the prescribed value from the No_PARENT state. The sensor node does not autonomously shift from the No_PARENT state to the No_PAN state and shifts to the No_PAN state by a push on the disJoin button.

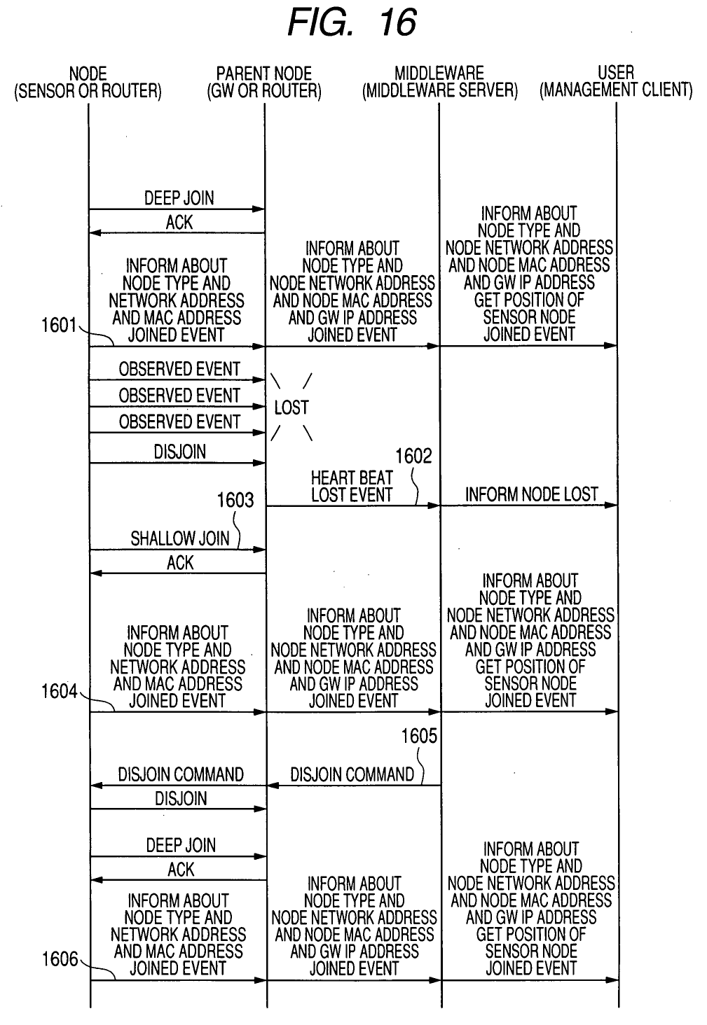

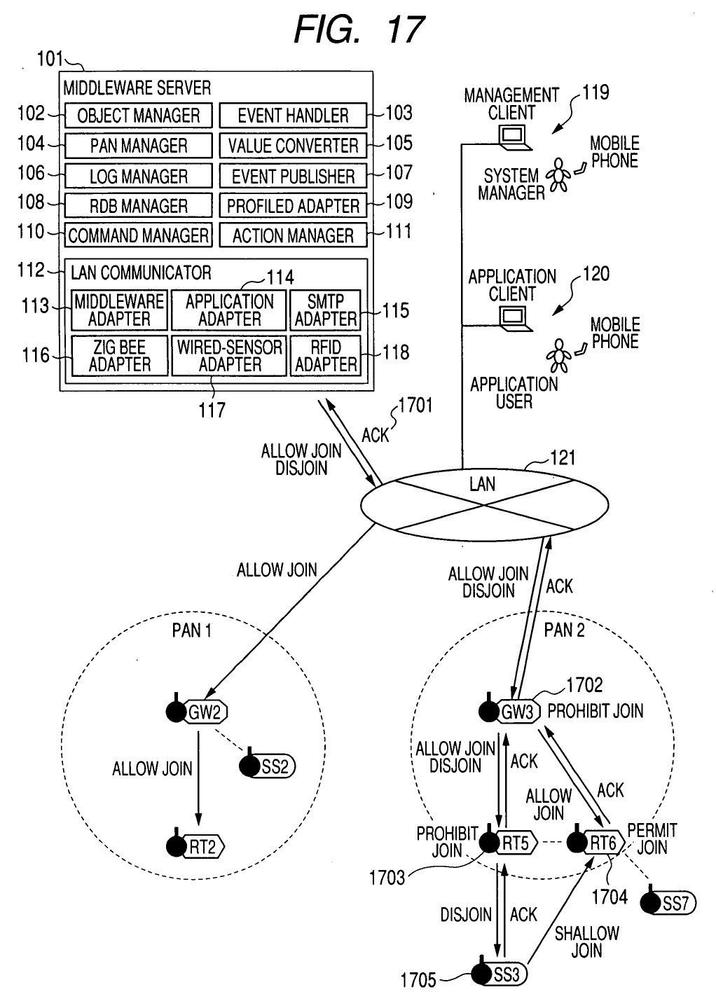

FIG. 16 shows a sequence chart relating to the Join operation resulting from the combination of a Shallow Join operation and a Deep Join operation. The sensor node starts a separate Deep Join operation to the gateway. After the Deep Join operation, the sensor node issues a Joined event to the gateway. Then, when the communication with the gateway has been disrupted for a value equal to or more than the prescribed value, the sensor node issues a disJoin command to shut off the communication with the PAN. And then, it starts a Shallow Join operation of starting a Join operation with the gateway with which it had established communication.

We will describe another embodiment of the radio communication system according to the present invention. FIG. 17 is a schematic illustration relating to the Allow Join command. The Allow Join command is a command for causing a shift to the allow state and not allow state for each of a plurality of routers and gateways constituting a PAN by the action of parameters within the command. By applying this system before starting a Deep Join operation, it is possible to specify not only the PAN to which the node is joined, but to which router constituting the PAN the node should be joined. When the gateway and the router to which node belongs are changed on the GUI, an instruction of reconstituting topology is given to the Action Manager from the GUI. Upon receipt of the instruction, the Action Manager informs the PAN Manager of the router and the gateway to which the node belongs on which a notice is given on the GUI, and the PAN Manager gives an instruction to the Command Manager on the gateway and the router to be shifted to the Allow Join state and issues an Allow Join command (1701). Upon receipt of the Allow Join command, the gateway (1702) and the routers (1703, 1704) shift to the Allow Join or the Not Allow Join state. Then, a disjoin command is issued to the sensor node (1702) to start a Join operation with the router to which it is allowed to join, and the communication with the desired router is established.

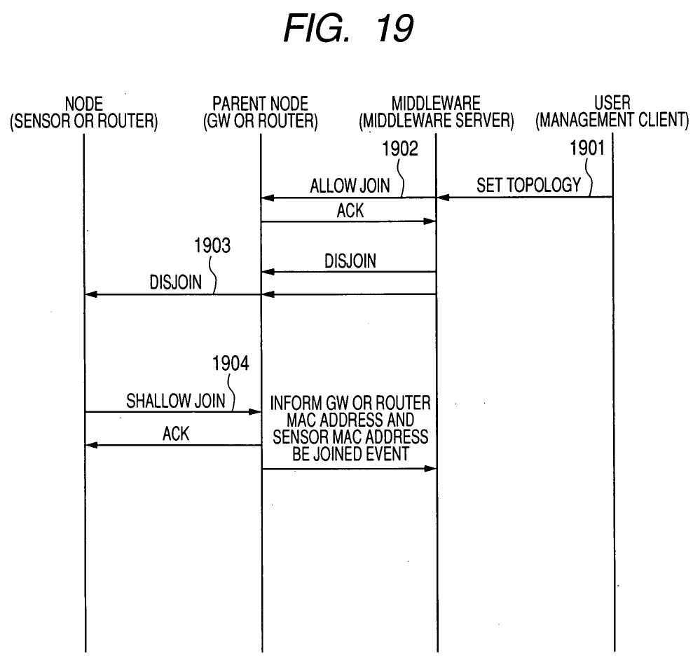

FIG. 19 shows a sequence chart relating to the Allow Join command. This sequence is used when it is hoped or not hoped to join a specific one of a plurality of routers in the PAN. When the gateway and the router to which node belongs are changed on the GUI, an instruction of refabricating topology is given to the Action Manager from the GUI. Upon receipt of the instruction, the Action Manager informs the PAN Manager of the router and the gateway to which the node belongs on which a notice is given on the GUI, and the PAN Manager gives an instruction to the Command Manager on the gateway and the router to be shifted to the Allow Join state and issues an Allow Join command. The Allow Join command designates the flag for giving the Allow Join and Not Allow Join command and the MAC Address to which the packets are sent and transmits packets. At this time, the nodes to which the Allow Join commands are issued are limited to the router and the gateway in the PAN to which they hope to belong. To the routers and gateways other than those mentioned above, an Allow Join command for shifting them to the Not Allow Join state is issued. Then, the PAN Manager issues a disjoin command to the sensor node (1903). Upon receipt of the disJoin command, the sensor node starts a Shallow Join operation (1904) for starting a Join operation with the same PAN, and establishes communication with the router to which a Allow Join command has been given.

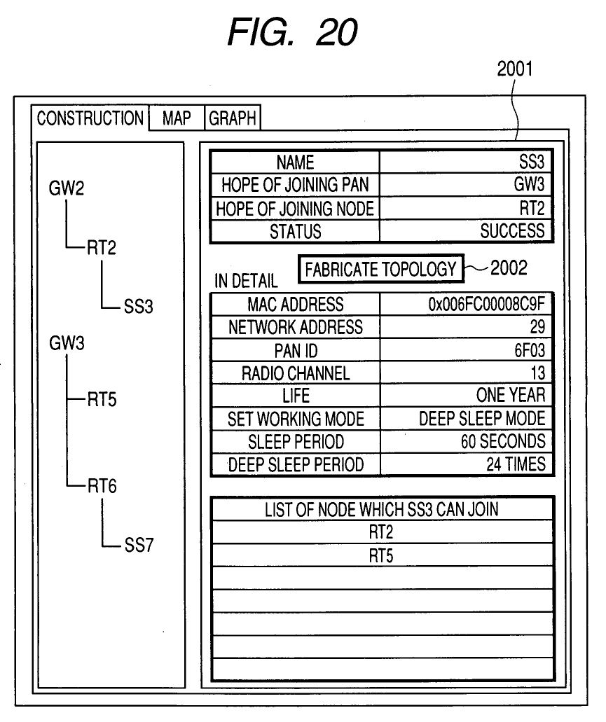

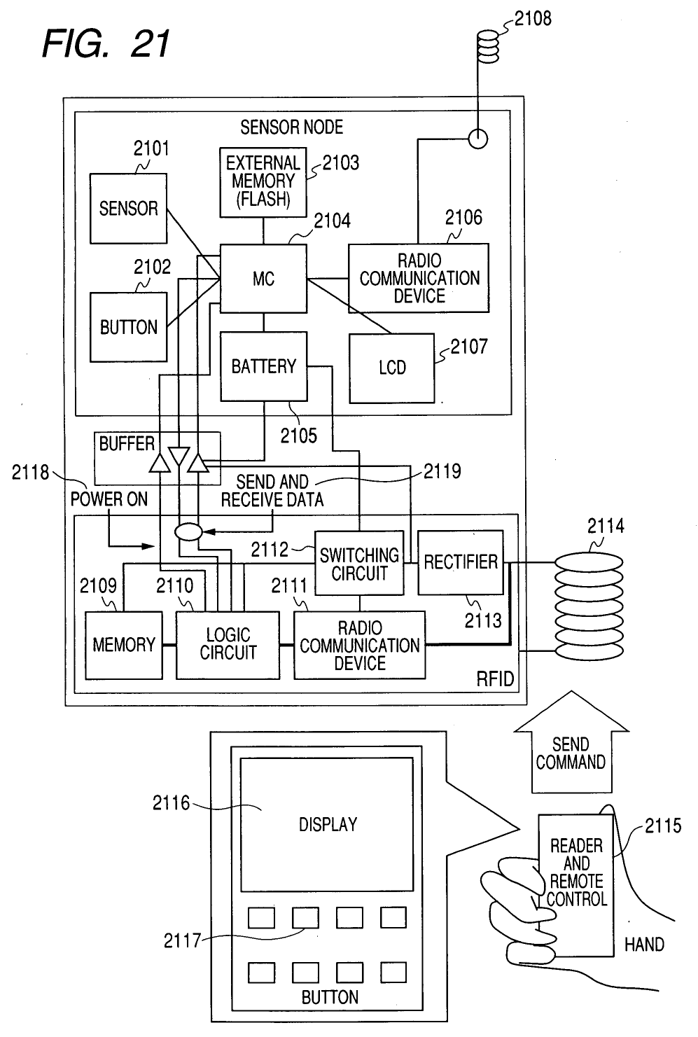

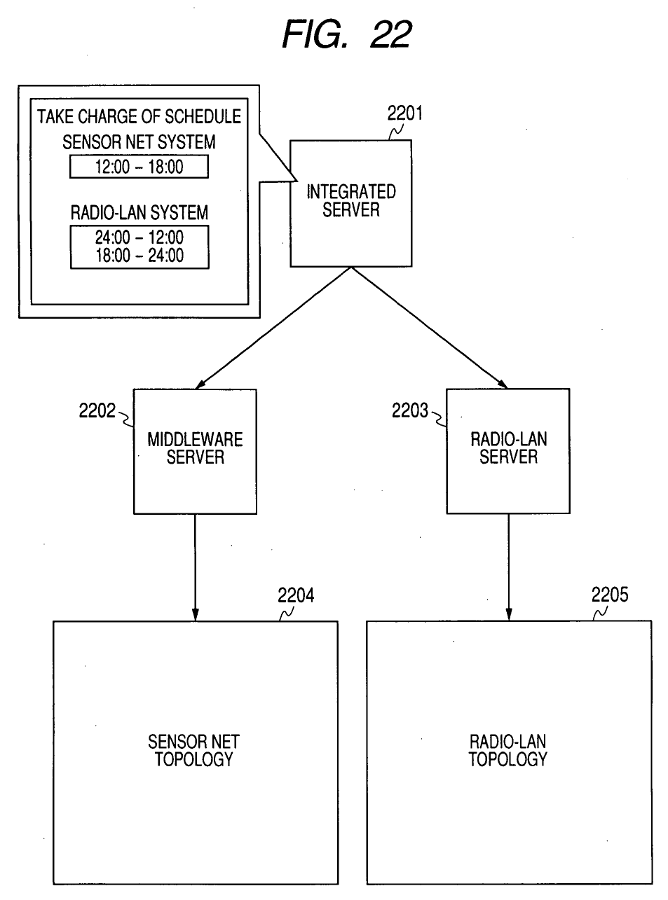

FIG. 20 shows the structure of the GUI. When the inputs for the gateway and the router are changed on the GUI shown in FIG. 20, and the Management Client has instructed the refabrication of topology by pressing on the fabricate topology button switch (2002), the GUI issues an instruction for the refabrication of topology to the Action Manager.

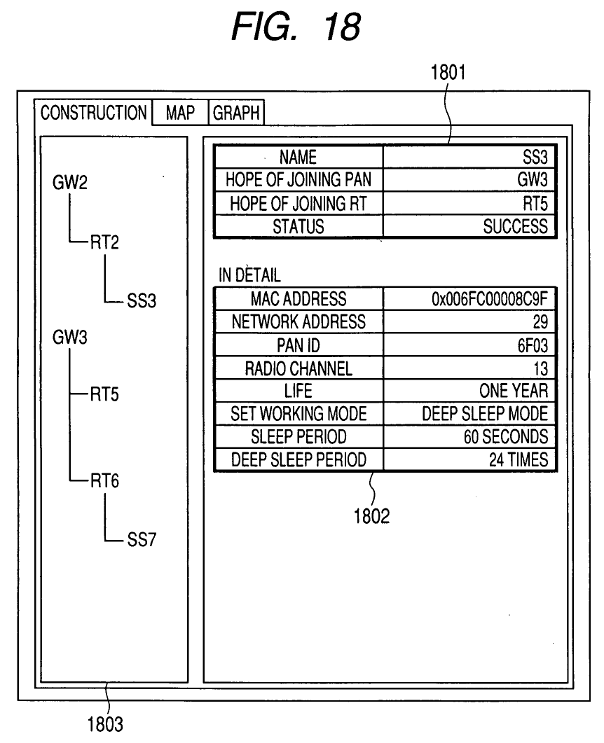

FIG. 18 of the present application shows a GUI on which the additional candidates for the router to start Join operation are entered. We will describe below an embodiment of the GUI image corresponding to the above sequence. After the Join operation, the sensor node issues a Joined event of transmitting the Network Address, the MAC Address and the Node Type of the node and the IP Address of the gateway to the middleware. And at the time of the Join operation, the router issues a beJoined event, transmits the MAC Address of the router to the gateway, and the gateway forwards the IP Address to the middleware. The middleware displays the detailed information and the layer structure of the PAN to which it belongs on the GUI from the MAC Address of the joined router and the IP Address of the gateway (1803). And it also displays the detailed information of the sensor node having made a Join operation (1802), the PAN to which it hopes to belong and the router (1801) on the GUI. There is also a method of using the Network Address as a method of displaying the layer structure. The Network Address is allocated and arranged among the sensor node, the gateway and the router. For example, if the maximum number of sensor nodes that can be joined with the router is set at 9, the Network Address of the router is 10, and the same for the sensor nodes joined with the router is set at 11, 12, 13 and so forth. And the inter multiples of 10 will be allocated to the other routers. The Network Address of the gateway is 0. It is possible to estimate the layer structure from this fact. As an example, if the Network Address of the router is 11 and that of the sensor node is 12, it will be possible to confirm that the sensor node is joined with the router whose Network Address is 11.

Furthermore, an embodiment of the hardware configuration of sensor node in another embodiment is shown in FIG. 12. In this embodiment, the sensor node is joined with RFID. The sensor node includes a Sensor (2101), a Button (2102), an External Memory (2103), a Battery (2105), a Radio Communication Device (2106), a LCD (2107), an Antenna (2108), and a Power Control Unit (2109). The RFID includes an Antenna (2114), a Rectifier (2113) for rectifying the high frequency signal inputted from the Antenna to direct current, a Switching Circuit (2112) for controlling the power voltage, a Radio Communication Device (2111) for communicating through the Antenna 2414, a Logic Circuit (2110) for controlling the communication data and a Memory (2109) for recording the ID information of the RFID and other additional information. The Switching Circuit can drive the Logic Circuit and the Memory by using the voltage of the Battery (2105) by switching the output voltage of the battery (2105) of the Sensor Node and the output voltage of the Rectifier even if the output voltage of the Rectifier is not a sufficient voltage for driving the Logic Circuit of the RFID and the Memory. The MC of the sensor node and the Logic Circuit of the RFID communicate through a Buffer. The Buffer is a level shift conversion circuit and converts the operating voltage of the RFID and the operating voltage of the MC. The Power ON (2118) constituting a signal line between the MC and the RFID constitutes the starting signal from the Logic Circuit of the RFID to the MC 2104 and the Power Control 2109. The Power Control having received the starting signal from the RFID switches on the power to shift the MC from the standby status to the operation status. And the Send and Receive Data (2119) constituting the signal line between the MC and the RFID transmits and receive data. By this, the MC and the Logic Circuit transmit and receive data such as commands and observational data.

The RFID Reader Writer (2115 Reader and Remote Control) includes a display (2116) and a plurality of command button switches (2117). On the display of the RFID reader, the command menu and the received data are displayed. The reader receives the temperature, humidity and battery voltage received from the Sensor (2101), the identification number (ID) of the sensor node and other information from the MC of the sensor node and display them on the display.

By a push on the command button switch, the RFID Reader transmits commands to the RFID. Upon receipt of the command, the RFID transmits starting signals from the Logic Circuit to the MC and starts the sensor node. It also transmits the commands to the MC corresponding to the received commands from the Logic Circuit to the MC to give instructions to the sensor node. By this series of operations, the sensor node can start up upon receipt of starting signals from the RFID even when it is in the Deep Sleep Mode. By provide a RFID on the sensor node, the Management Client can not only control commands from the middleware but also control sensor nodes while working on the site.

The commands can be divided into three types. The first type is the command that gives instructions of operation from the RFID to the sensor node. For example, there are command for shifting the sensor node from the Deep Sleep Mode to the working mode, command for resetting the MC to initialize the same, command for transmitting the data given by the RFID reader, or various data including the sensing data that the sensor node has as radio packets from the sensor node to the gateway, command for disjoining or joining again and the like. The second type is the command for sending data from the RFID reader to the sensor node; for example, a command to rewrite the data on the starting time interval of the sensor node, a command for rewriting the program memory itself of the MC to change the program, or the like. The third type is a command for reading the information contained in the sensor node via RFID. For example, command to read the temperature, humidity or battery voltage outputted by the Sensor (2201) and other sensing information or the identification number of the sensor node, or the starting time interval of the sensor node, or the PAN ID to which the sensor node has joined at present or its channel number and other data. In this way, the Management Client can give direct instructions to the sensor node by going on the site and using the reader. And it is possible to see the sensor node data via the reader not only in the middleware on the Management Client PC but also on the site.

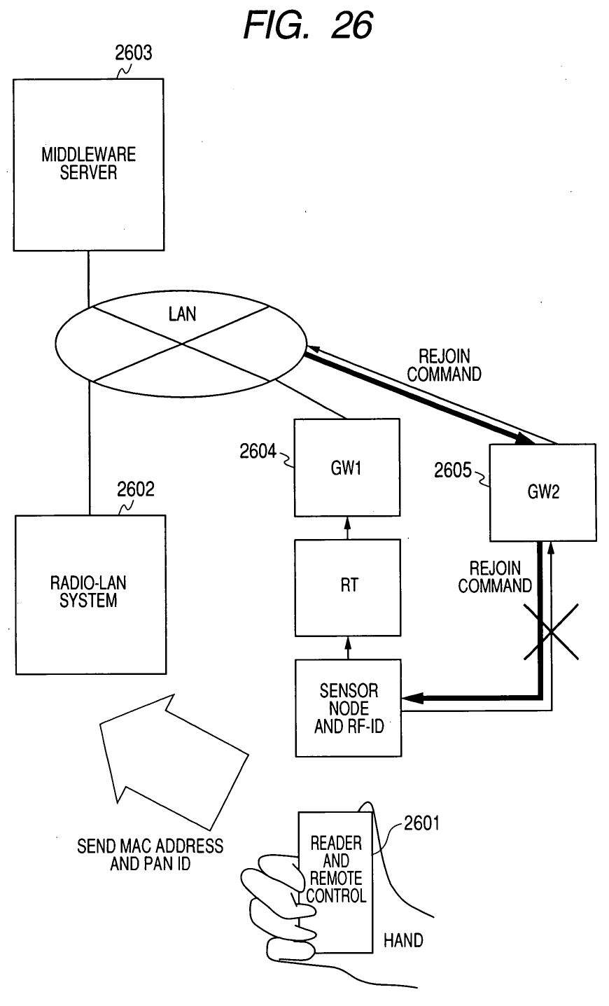

FIG. 26 is a conceptual illustration of an embodiment of the system using the terminals according to this embodiment. The Management Client inputs the topology to be fabricated in the middleware by the Middleware Server. The Management Client reads the MAC Address of the sensor node by using the RF-ID reader having a radio LAN. Upon receipt of the MAC Address, the RF-ID reader transmits the MAC Address to the Middleware Server via the radio LAN system (2602). Based on the received information, the Middleware Server (2603) issues a ReJoin Command to the sensor node and instructs to shift to GW1 (2604) if the sensor node having the designated MAC Address has joined GW2 (2605) unlike the system structure that the Management Client hopes.

Then, we will show a block diagram showing the system configuration of an embodiment for making adjustments between systems. We will cite an example of radio LAN system as the other system. A Middleware Server (2202) for controlling the Sensor Net System and a radio LAN server (2203) for controlling other systems are controlled by a control server (2201), and the control server controls the schedule of the radio LAN system and the Sensor Net System. The schedule is a table of managing at what time zone the user of the radio LAN system we have cited for example uses the radio LAN system. And the whole Sensor Net System (2204) is brought to a system down or is driven as a system based on the schedule, and its schedule is adjusted with the radio LAN system (2205). For example, the schedule time is inputted on the GUI, and when it is hoped to start the system, a flag for system up is hoisted, and when a system down is hoped, the flag is lowered.

In this case, the adjustments among various systems are made by time-sharing. Sometimes, however, system adjustments may be made by frequency-sharing. In the case of system adjustments made by frequency-sharing, the control server manages the frequencies used by the radio communication between the radio LAN system and the Sensor Net System, and issues commands for allocating frequencies to each system so that no cross-talk may occur. Each system communicates by using the frequency allocated to them.

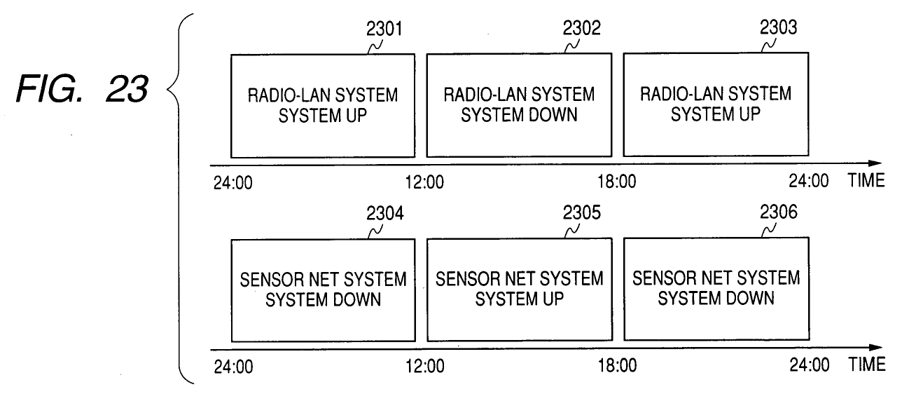

A conceptual illustration of time-sharing is shown in FIG. 23. For example, the radio LAN system is operated during the day (2305) and the Sensor Net System is operated during the night (2301). Such time-sharing enables to prevent any cross talk with other systems.

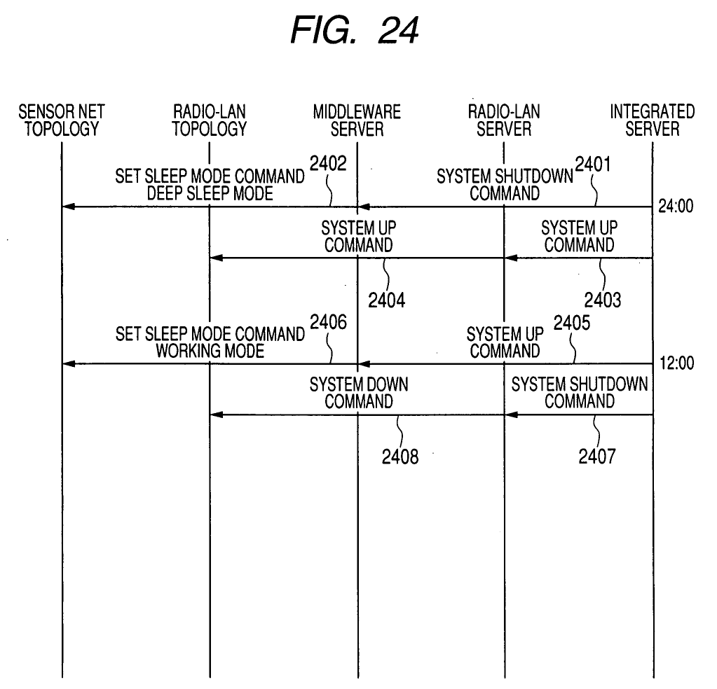

A sequence chart is shown in FIG. 24. The server for controlling the radio LAN server and the Middleware Server controls the schedule of the radio LAN system and the Sensor Net System, and in the case of bringing the Sensor Net System to a system down, a System down Command for stopping the operation of the whole system is transmitted to the Middleware Server (2401). Upon receipt of a System down Command, the Middleware Server transmits a Set Sleep Mode command to the sensor node, and instructs the sensor node to operate in the Deep Sleep Mode in which the sleep interval of the sensor node is long (normally approximately five minutes, and the one for the Deep Sleep Mode is 10 hours). The Set Sleep Mode command contains a flag for controlling the operational mode of the sensor node. The operational mode includes the Deep Sleep Mode and the Working Mode constituting the normal operational mode.

For operating the system of the Sensor Net System, a System Up Command for driving the whole system is transmitted to the Middleware Server (2401). Upon receipt of a System Up Command, the Middleware Server transmits a Set Sleep Mode command to the sensor node, and instructs the sensor node to operate in the working mode. By coordinating the time of use with other systems in this way, it is possible to prevent any interference with other systems and to obtain highly reliable information.

What is claimed is:

1. A Sensor Net System comprising an intermediate device joined with a sensor node and a server joined with said intermediate device, said server comprising:
a record unit for recording the relationship of joining between said nodes to be joined and the network to which said intermediate device belongs;
a display unit for displaying said relationship of joining;
an input unit for accepting changes in said relationship of joining;
a command issue unit for issuing a rejoining command based on said judgment; and
a transmission and reception unit for transmitting said issued commands to the intermediate device joined with said a sensor node,
wherein upon receiving said command, said sensor node shuts down the joining with said intermediate device, searches the network specified in said command and joins with the intermediate device belonging to the network searched.

2. The Sensor Net System according to claim 1,
wherein said sensor node searches communicable networks and chooses any one of the searched networks, and
wherein joins with said intermediate device belonging to said chosen network.

3. The Sensor Net System according to claim 1,
wherein in case of failures for the predetermined number of times or more to join with said intermediate device to be joined, said sensor node repeatedly tries to join with said intermediate device until the joining is completed with the same.

4. The Sensor Net System according to claim 1,
wherein said command issue unit issues the first Allow Join command including the allow join information for allowing joining with some intermediate devices constructing said network and issues the second Allow Join command including the information of not allowing joining with the intermediate devices other than those mentioned above,
wherein said intermediate device, upon receipt of said allow joint command, switches the allow join state based on the instruction of said Allow Join command, and
wherein said sensor node trying to join with said network joins with any one of the intermediate devices having received said first Allow Join command.

5. The Sensor Net System according to claim 1,
wherein said command issue unit issues a Deep Sleep Mode command, and
wherein the sensor node, upon receipt of said deep sleep command, operates in the Deep Sleep Mode in which sleep time is set longer.

6. The Sensor Net System according to claim 1, wherein said server display unit displays the relationship of joining among said server constructing said sensor net, said intermediate device and said sensor node in the layer structure.

7. The Sensor Net System according to claim 1,
wherein said server further comprises a judgment unit for judging whether the relationship of joining between said sensor node and network that has been notified exists or not based on the relationship of joining recorded as mentioned above, and
wherein, when said judgment unit has judged it as inappropriate, said command issue unit issues a ReJoin Command to said sensor node.

8. The Sensor Net System according to claim 1,
wherein said Sensor Net System shares said network with other communication systems, and comprises further a management device, and
wherein said management device manages the allocation of frequencies between said Sensor Net System and said other systems.

9. The Sensor Net System according to claim 2,
wherein the priority for various network candidates is decided by using said radio field intensity in said network search, and said Join operations are executed based on said priority.

10. A sensor node joined with intermediate devices in a Sensor Net System including a server and a plurality of intermediate devices managed by said server, said sensor node comprising:
a communication unit for communicating by radio with said intermediate devices;
a display unit;
an input instruction unit; and
a control unit for controlling said different units,
wherein said sensor node searches networks through said communication unit,displays the retrieved networks in said display unit, and joins with the intermediate devices belonging to the chosen network through said input instruction unit, and
wherein, upon receipt of the ReJoin Command issued by said server between the network and said sensor node through said communication unit, said control unit shuts down the joining with said intermediate devices, searches the intermediate devices belonging to the network designated in the command and joins with the retrieved intermediate devices.

11. The sensor node according to claim 10,
wherein said control unit interrupts the joining with said intermediate devices according to the instructions received through said input instruction means.
